(19) United States
(12) Patent Application Publication
(10) Pub. No.: US 2008/0085191 A1
(43) Pub. Date: Apr. 10, 2008

(54) Thermal barrier coating system for a turbine airfoil usable in a turbine engine

(75) Inventor: George Liang, Palm City, FL (US)

Correspondence Address: Siemens Corporation;Intellectual Property Department, 170 Wood Avenue South, Iselin, NJ, 08830, US

(73) Assignee: Siemens Power Generation, Inc.

(21) Appl. No.: 11/543,649

(22) Filed: Oct. 5, 2006

(51) Int. Cl. F03B 3/12

(52) U.S. Cl. 416/241 R

(57) ABSTRACT

A turbine airfoil usable in a turbine engine and having at least one cooling system with at least a portion of the cooling system positioned in internal aspects of the airfoil. The airfoil may also include a thermal barrier coating attachment system for attaching a thermal barrier coating to the airfoil. In one embodiment, the thermal barrier coating may be formed from one or more grooves in an outer surface of the outer wall forming the turbine airfoil. The grooves may have different cross-sectional shapes to enhance attachment of the thermal barrier coating to the airfoil.

### FIELD OF THE INVENTION

This invention is directed generally to turbine airfoils, and more particularly to hollow turbine airfoils having cooling channels for passing fluids, such as air, to cool the airfoils.

### BACKGROUND

Typically, gas turbine engines include a compressor for compressing air, a combustor for mixing the compressed air with fuel and igniting the mixture, and a turbine blade assembly for producing power. Combustors often operate at high temperatures that may exceed 2,500 degrees Fahrenheit. Typical turbine combustor configurations expose turbine vane and blade assemblies to these high temperatures. As a result, turbine vanes and blades must be made of materials capable of withstanding such high temperatures. In addition, turbine vanes and blades often contain cooling systems for prolonging the life of the vanes and blades and reducing the likelihood of failure as a result of excessive temperatures.

Typically, turbine vanes are formed from an elongated portion forming a vane having one end configured to be coupled to a vane carrier and an opposite end configured to be movably coupled to an inner endwall. The vane is ordinarily composed of a leading edge, a trailing edge, a suction side, and a pressure side. The inner aspects of most turbine vanes typically contain an intricate maze of cooling circuits forming a cooling system. The cooling circuits in the vanes receive air from the compressor of the turbine engine and pass the air through the ends of the vane adapted to be coupled to the vane carrier. The cooling circuits often include multiple flow paths that are designed to maintain all aspects of the turbine vane at a relatively uniform temperature. At least some of the air passing through these cooling circuits is exhausted through orifices in the leading edge, trailing edge, suction side, and pressure side of the vane.

Many conventional turbine vanes also include thermal barrier coatings for insulating the turbine vanes from the hot gas flow. While the thermal barrier coatings have been successful, the thermal barrier coatings are often susceptible to becoming detached from the turbine vanes. Consequently, these areas where the thermal barrier coatings detach are more susceptible to thermal degradation and over temperatures. Thus, a need exists for a turbine vane having a thermal barrier coating attachment system with an increased ability to retain a thermal barrier coating on the turbine vane.

### SUMMARY OF THE INVENTION

This invention relates to a turbine airfoil cooling system configured to cool internal and external aspects of a turbine airfoil usable in a turbine engine. In at least one embodiment, the turbine airfoil cooling system may be configured to be included within a stationary turbine vane. The turbine airfoil cooling system may include one or more internal cooling cavities having any one of a variety of appropriate configurations. The turbine airfoil cooling system may also include a thermal barrier coating attachment system for facilitating a resilient attachment of a thermal barrier coating to the turbine airfoil.

The thermal barrier coating attachment system may be attached to a turbine airfoil formed from a generally elongated hollow airfoil formed from an outer wall, and having a leading edge, a trailing edge, a pressure side, a suction side, a first endwall at a first end, and a second endwall at a second end opposite the first end. In one embodiment, the thermal barrier coating attachment system may include one or more grooves in an outer surface of the outer wall of the turbine airfoil. The thermal barrier coating may be applied to the grooves in the outer wall of the generally elongated hollow airfoil. The thermal barrier coating may form a coating on at least a portion of the outer surface of the outer wall. The grooves may have any configuration to enhance the ability of the thermal barrier coating to attach to the outer surface of the turbine airfoil. For instance, the grooves may have a generally rectangular shaped cross-section, a generally semi-circular shaped cross-section, or a dovetail shaped cross-section.

The turbine airfoil may also include one or more cooling systems formed by at least one cavity positioned in the generally elongated hollow airfoil. The cooling system may be formed from one or more impingement ribs positioned in close proximity to the outer wall forming an outer wall chamber. The cooling system may also include a plurality of fins extending between the at least one rib and the outer wall. The impingement rib may include a plurality of impingement orifices. The impingement orifices may be offset from the fins.

An advantage of this invention is that the thermal barrier coating attachment system increases the effective thickness of the thermal barrier coating, which reduces the airfoil metal temperature by a larger margin than conventional systems and results in a savings of cooling fluids.

Another advantage of this invention is that the grooves in the outer surface of the outer wall reduce the airfoil hot side convection surface, thereby reducing the heat load into the airfoil.

Still another advantage of this invention is that the grooves increase the surface area to which the thermal barrier coating is bonded, thereby increasing the ability of the thermal barrier coating to successfully attached to the turbine airfoil.

Another advantage of the invention is that during operation, the thermal barrier coating in the grooves is under compression, which prolongs the useful life of the thermal barrier coating by preventing the coating from separating from the airfoil.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a perspective view of a turbine airfoil having features according to the instant invention.

FIG. 2 is a cross-sectional view of the turbine airfoil shown in FIG. 1 taken along line 2-2.

FIG. 3 is a detailed view of the turbine airfoil with a thermal barrier coating attachment system taken along line 3-3 in FIG. 2.

FIG. 4 is a detailed view of the turbine airfoil with an alternative embodiment of the thermal barrier coating attachment system taken along line 4-4 in FIG. 2.

FIG. 5 is a detailed view of the turbine airfoil with an another alternative embodiment of the thermal barrier coating attachment system taken along line 5-5 in FIG. 2.

FIG. 6 is a partial top plan view of an outer surface of the turbine airfoil with grooves.

FIG. 7 is a partial top plan view of an outer surface of the turbine airfoil with an alternative configuration of the grooves.

### DETAILED DESCRIPTION OF THE INVENTION

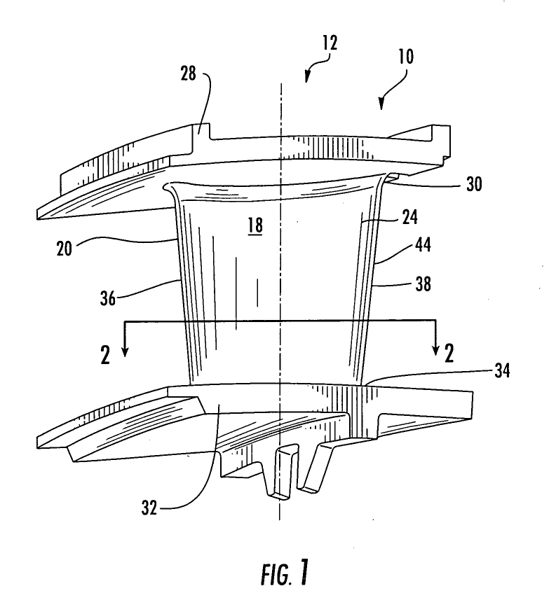

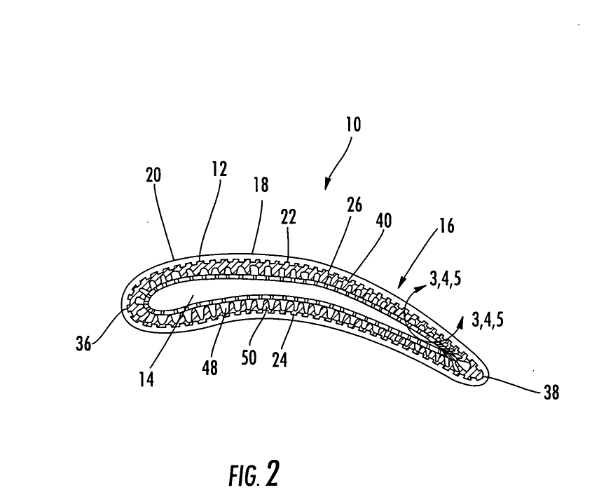

As shown in FIGS. 1-7, this invention is directed to a turbine airfoil cooling system 10 configured to cool internal and external aspects of a turbine airfoil 12 usable in a turbine engine. In at least one embodiment, the turbine airfoil cooling system 10 may be configured to be included within a stationary turbine vane, as shown in FIGS. 1-7. The turbine airfoil cooling system 10 may include one or more internal cooling cavities 14 having any one of a variety of appropriate configurations. The turbine airfoil cooling system 10 may also include a thermal barrier coating attachment system 16 for facilitating a resilient attachment of a thermal barrier coating 18 to the turbine airfoil 12. The thermal barrier coating 18 may be formed from any material capable of insulating the turbine airfoil 12 from the hot temperatures encountered in the turbine engine.

As shown in FIG. 1, the turbine airfoil 12 may be formed from the generally elongated hollow airfoil 20 having an outer surface 22 adapted for use, for example, in an axial flow turbine engine. Outer surface 22 may have a generally concave shaped portion forming the pressure side 24 and a generally convex shaped portion forming the suction side 26. The turbine vane 12 may also include an outer endwall 28 at a first end 30 adapted to be coupled to a hook attachment and may include an inner endwall 32 at a second end 34. The generally elongated hollow airfoil 20 may also include the leading edge 36 and a trailing edge 38.

As shown in FIGS. 1-7, the turbine airfoil cooling system 10 may include the thermal barrier coating attachment system 16. The thermal barrier coating system 16, as shown in FIGS. 3-7, may be formed from one or more grooves 40 in an outer surface 22 of an outer wall 44 forming the turbine airfoil 12. In one embodiment, the outer wall 44 may have a thickness of between about 0.15 inches and 0.25 inches. In such an embodiment, the grooves 40 my be etched into the outer surface 22 with a laser. The grooves 40 may have a width generally equal to the thickness of the thermal barrier coating 18. The depth of the groove 40 may be between about one to two times the thickness of the thermal barrier coating 18. In one embodiment, the grooves 40 may be between about 0.02 inches and about 0.06 inches in depth. In other embodiments, the grooves 40 may be formed in other appropriate manners and in other depths and widths.

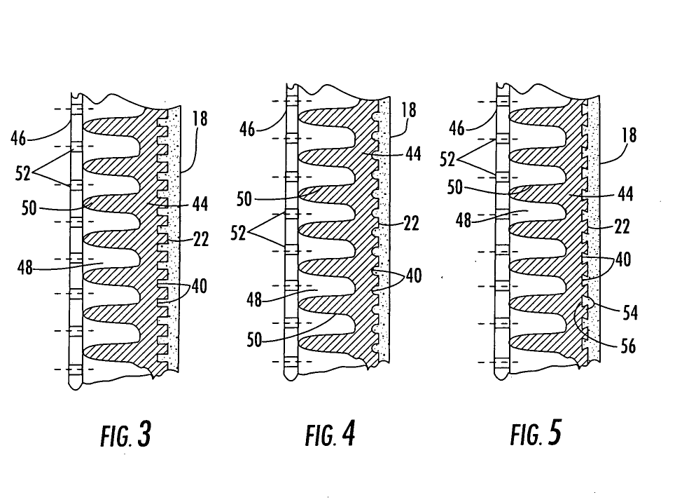

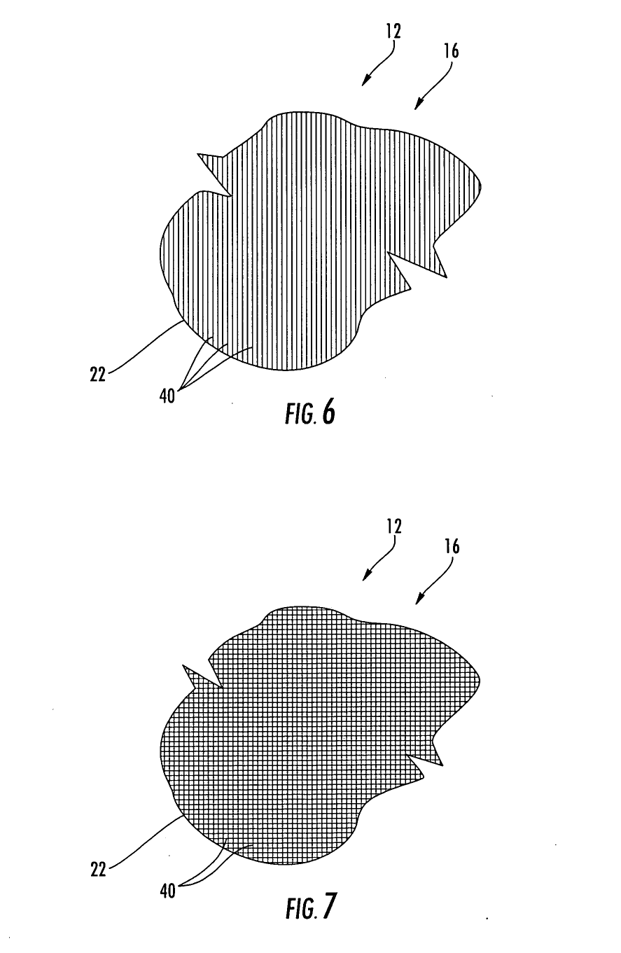

The grooves 40 may be spaced equidistant from each other. In another embodiment, the grooves 40 may be spaced at varying distances from each other. The grooves 40 may be linear or non-linear. As shown in FIG. 6, the grooves 40 may be positioned generally linear to each other. The grooves 40 may be parallel or orthogonal to a longitudinal axis of the turbine airfoil 12. As shown in FIG. 7, the grooves 40 may crisscross each other. The grooves 40 may also extend into the outer wall 44 normal to the outer surface 22, as shown in FIGS. 3 and 4, or at an angle, as shown in FIG. 5. The grooves 40 may be angled such that a throat 54 has a width that is less than a width of the bottoms 56 of the grooves 40.

As shown in FIGS. 3-5, the grooves 40 may have different shaped cross-sectional areas to increase the resistance of the thermal barrier coating 18 from being detached from the turbine airfoil 12. For instance, the grooves 40 may have a rectangular shaped cross-section, as shown in FIG. 3, a semi-circular cross-section, as shown in FIG. 4, or a dovetail shaped cross-section, as shown in FIG. 5. The grooves 40 may have other appropriately shaped cross-sections for enhancing attachment of the thermal barrier coating 18 to the outer surface 22. The thermal barrier coating 18 may fill the grooves 40 and may be coated onto a portion of or all of the outer surface 22 of the outer wall 44.

The turbine airfoil cooling system 10 may include an impingement rib 46 positioned in close proximity to the outer wall 44. The impingement rib 46 may form a cooling cavity 48 between the outer wall 44 and the impingement rib 46. One or more fins 50 may extend between the outer wall 44 and the impingement rib 46. The impingement rib 46 may include one or more impingement orifices 52. As shown in FIGS. 3-5, the impingement orifices 52 may be offset from the fin 50.

During use, hot combustor gases contact the thermal barrier coating 18 on the airfoil 12. The thermal barrier coating 18 insulates the airfoil 12 from exposure to the high temperatures of the hot combustor gases. The grooves 40 of the thermal barrier coating attachment system 16 reduce the likelihood that that the thermal barrier coating 18 will separate from the outer surface 22 of the outer wall 44 and experience over temperatures. In particular, expansion of the airfoil 12 due to thermal expansion compresses the thermal barrier coating 18 within the grooves 40, thereby increasing the resistance to detachment of the thermal barrier coating 18 and prolonging the useful life of the thermal barrier coating 18.

The foregoing is provided for purposes of illustrating, explaining, and describing embodiments of this invention. Modifications and adaptations to these embodiments will be apparent to those skilled in the art and may be made without departing from the scope or spirit of this invention.

I claim:

1. A turbine airfoil, comprising:
a generally elongated hollow airfoil formed from an outer wall, and having a leading edge, a trailing edge, a pressure side, a suction side, a first endwall at a first end, a second endwall at a second end opposite the first end;
at least one cooling system formed by at least one cavity positioned in the generally elongated hollow airfoil;
wherein the outer wall includes at least one groove in an outer surface of the outer wall; and
at least one thermal barrier coating positioned in the at least one groove in the outer wall of the generally elongated hollow airfoil and forming a coating on at least a portion of the outer surface of the outer wall.

2. The turbine airfoil of claim 1, further comprising a plurality of grooves on the outer surface of the outer wall.

3. The turbine airfoil of claim 1, wherein the at least one groove has a generally rectangular shaped cross-section.

4. The turbine airfoil of claim 1, wherein the at least one groove has a generally semi-circular shaped cross-section.

5. The turbine airfoil of claim 1, wherein the at least one groove has a dovetail shaped cross-section.

6. The turbine airfoil of claim 1, wherein the at least one cooling system is formed from at least one impingement rib positioned in close proximity to the outer wall forming an outer wall chamber and further comprising a plurality of a plurality of fins extending between the at least one rib and the outer wall.

7. The turbine airfoil of claim 6, wherein the at least one impingement rib further comprises a plurality of impingement orifices.

8. The turbine airfoil of claim 7, wherein the plurality of impingement orifices are offset from the fins.

9. The turbine airfoil of claim 1, wherein the at least one groove has a width generally equal to a thickness of the thermal barrier coating.

10. The turbine airfoil of claim 9, wherein a depth of the groove may be between about one and two times the thickness of the thermal barrier coating.

11. A turbine airfoil, comprising:
a generally elongated hollow airfoil formed from an outer wall, and having a leading edge, a trailing edge, a pressure side, a suction side, a first endwall at a first end, a second endwall at a second end opposite the first end;
at least one cooling system formed by at least one cavity positioned in the generally elongated hollow airfoil;
wherein the outer wall includes a plurality of grooves in an outer surface of the outer wall; and
at least one thermal barrier coating applied to the grooves in the outer wall of the generally elongated hollow airfoil and forming a coating on at least a portion of the outer surface of the outer wall.

12. The turbine airfoil of claim 11, wherein at least one of the grooves has a generally rectangular shaped cross-section.

13. The turbine airfoil of claim 11, wherein at least one of the grooves has a generally semi-circular shaped cross-section.

14. The turbine airfoil of claim 11, wherein at least one of the grooves has a dovetail shaped cross-section.

15. The turbine airfoil of claim 11, wherein the at least one cooling system is formed from at least one impingement rib positioned in close proximity to the outer wall forming an outer wall chamber and further comprising a plurality of a plurality of fins extending between the at least one rib and the outer wall.

16. The turbine airfoil of claim 15, wherein the at least one impingement rib further comprises a plurality of impingement orifices.

17. The turbine airfoil of claim 16, wherein the plurality of impingement orifices are offset from the fins.

18. The turbine airfoil of claim 11, wherein at least one of the grooves has a width generally equal to a thickness of the thermal barrier coating.

19. The turbine airfoil of claim 18, wherein a depth of at least one of the grooves may be between about one and two times the thickness of the thermal barrier coating.
